(19) United States
(12) Patent Application Publication
(10) Pub. No.: US 2001/0035992 A1
(43) Pub. Date: Nov. 1, 2001

(54) Bus station for an optical bus system

(76) Inventors: Vasco Vollmer, Gartow (DE); Nikolaus Schunk, Hildesheim (DE); Wolfgang Detlefsen, Hildesheim (DE); Wolfgang Baierl, Remshalden (DE)

Correspondence Address: KENYON & KENYON, ONE BROADWAY, NEW YORK, NY, 10004, US

(21) Appl. No.: 09/822,541

(22) Filed: Mar. 30, 2001

(30) Foreign Application Priority Data
Mar. 31, 2000 (DE) 1 00 16 173.1

(51) Int. Cl. H04B 10/20; H04J 14/00; H04B 10/12

(52) U.S. Cl. 359/118; 359/173

(57) ABSTRACT

A bus station for an optical bus system includes an input stage and an address detection device. The address detection device is deactivated in a first rest state.

### BACKGROUND INFORMATION

Bus stations for an optical bus system are already known where the bus station is partially deactivated. However, in optical bus systems, it must be ensured even in the rest (quiescent) state that the optical signals are relayed, since, otherwise, all bus stations arranged downstream from the bus station are also deactivated. Therefore, a residual functionality suitable for recognizing addresses must always be maintained.

### SUMMARY OF THE INVENTION

In contrast to the related art, the bus station according to the present invention has the advantage that the bus station is almost entirely deactivated in a rest state. The energy consumption of the bus station can, therefore, be kept very minimal.

By providing a second rest state, the bus station can be deactivated to varying degrees as a function of the requirements of the bus system, and, thus, the energy consumption of the bus station can be accordingly reduced. The bus station, either itself or as a function of external commands, can activate the first and/or second rest state. Furthermore, it can be provided that, in one of the rest states, the bus station is still capable of relaying optical signals.

### BRIEF DESCRIPTION OF THE DRAWINGS

FIG. 1 shows an optical bus system.

FIG. 2 shows the internal design of a bus station.

FIG. 3 shows the design of an input stage of a bus station.

### DETAILED DESCRIPTION

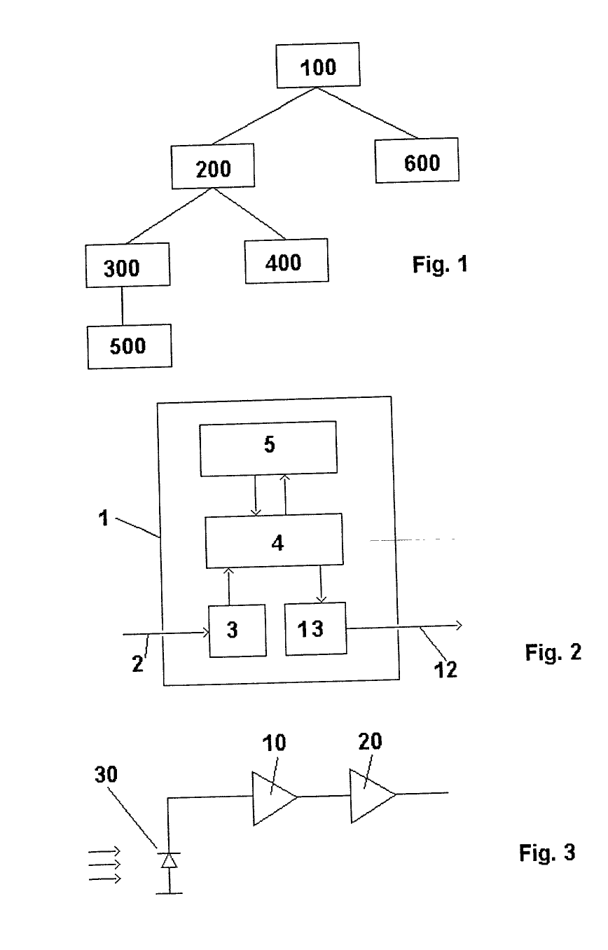

FIG. 1 shows a bus system having a plurality of bus stations 100, 200, 300, 400, 500, and 600, in which the individual bus stations are connected by optical lines, i.e., optical fibers (waveguides). Each of these connections enables the bus stations to transmit and receive data. Bus stations 400, 500, and 600 are each only connected to one bus station, while bus stations 100, 200, and 300 have more than one connection. To enable a data communication between bus station 100 and bus stations 300, 400, and 500, bus station 200 must be designed so that it can pass on messages received from station 100 to stations 300 and 400. Bus station 300 must also be designed so that it repeats messages received from bus station 200 and intended for bus station 500. In this context, different procedures can be used. First of all, it can be provided that all bus stations that are connected to more than one bus station automatically send every message that they receive at an input to the output in order to ensure that messages are distributed throughout the entire bus system. Alternatively, it can also be provided that the bus stations examine an address of the message and, as a function of the address, repeat the message at every output, repeat it only at one output, or do not repeat it at all. In the case of bus station 200, it could be provided, for example, that bus station 200 always repeats at both outputs every message received from bus station 100. Alternatively, it could also be provided that bus station 200 repeats every message unless it recognizes that the message is intended for bus station 200. This means that bus station 200 checks all messages received from bus station 100 for an address, and if the address does not include the value “200,” it repeats this value (message) at the inputs. Furthermore, it can be provided that bus station 200 knows which bus station is linked to which output of bus station 200. Thus, if a message having the address 400 is transmitted by bus station 100, bus station 200 would only repeat this message at the output at which it is linked to bus station 400. A message for bus station 500 would be repeated by bus station 200 at the output connected to bus station 300. This procedure naturally requires that bus station 200 has information regarding the entire subsequent bus system.

Bus stations 400, 500, and 600 are only linked to one single bus station, and therefore, it is necessary that these bus stations repeat messages. These bus stations can, therefore, have a particularly simple design.

Since the connection between the individual bus stations is produced by optical signal lines, the bus stations cannot be supplied with energy via the bus lines since the amount of energy that can be transported via optical signal lines is too small. Thus, every bus station has its own energy supply. Provided that part of the bus system or individual bus stations are not partaking in a data exchange with other bus stations for an extended period of time, it can be advantageous in the case of individual bus stations to provide a rest state in order to reduce the energy demand of the bus station for a particular period of time. This is of particular interest when individual bus stations have their own local energy supplies, typically from a battery or another storage element. The decision to enter a rest state can be autonomously made by the bus station itself, or else a superordinate bus station, which decides in the manner of a bus manager which bus station is to be forced into the rest state, is provided in the bus system.

In the case of individual bus stations being transitioned into a rest state, it must, however, be taken into consideration that the bus stations detect different functions in the entire network. If bus stations 400, 500, and 600 are switched completely off, those bus stations are, therefore, no longer attainable, and they no longer partake in any data exchange. However, starting from bus station 100, for example, stations 300, 400, and 500 can no longer be reached if station 200 is sent into a total rest state. Therefore, bus station 200 can only be completely deactivated if it is simultaneously ensured that communication with bus stations 300, 400, and 500 is no longer necessary.

Thus, the present invention proposes providing different rest states. In this context, the bus station is largely deactivated in a first rest state, which, in the case of bus station 200, would mean that the bus station is no longer capable of transmitting messages from bus station 100 to bus stations 300, 400, and 500. A second rest state is also provided in which the bus station is largely deactivated, yet signals can still be relayed. In the case of bus station 200, this means that bus station 200 is deactivated to a large extent and can neither receive nor transmit messages, yet is still capable of relaying messages from bus station 100 to bus stations 300, 400, and 500.

FIG. 2 explains the internal design of the bus stations according to FIG. 1. In FIG. 2, one of the bus stations according to FIG. 1 is designated as 1. Bus station 1 has an input 2 and an output 12 for an optical signal line. If the bus station is one of the bus stations 100, 200, and 300, a correspondingly greater number of inputs 2 and outputs 12 are provided for signal lines. The signal lines are connected to an input stage 3 and an output stage 13. Input stage 3 is used to convert optical signals, which are transmitted via the bus line to bus station 1, to electrical signals. Output stage 13 is used to convert electrical signals in the interior of bus station 1 to optical signals, which are then transmitted via the bus line. Input stage 3 and output stage 13 are connected via an internal data line to an address detection device 4. Address detection device 4 is linked via internal data lines to a device 5 for further processing.

In a completely activated state, all subdevices of bus station 1 shown in FIG. 2 are activated. Input stage 3 receives data via the optical signal line and converts them to internal electrical signals to be further processed in bus station 1. Furthermore, output stage 13 receives internal signals of bus station 1 and converts them to corresponding optical signals, which are then transmitted via the optical signal lines to other bus stations. Address detection device 4 receives from input stage 3 the data received across the optical signal line. It evaluates these signals to detect addresses included in the messages transmitted via the optical signal lines. Address detection device 4 induces further actions as a function of the detected addresses. If address detection device 4 detects that the message is intended for another bus station, or that it is a message intended for all bus stations, the address detection device causes output stage 13 to repeat the message accordingly. If address detection device 4 detects that the message is relevant to bus station 1, it causes the message to be accordingly relayed to device 5 for further processing to be further, internally processed in bus station 1.

FIG. 2 shows input stage 3 and output stage 13 as two separate devices. Alternatively, it is, however, also possible that the input stage and the output stage are one uniform device.

According to the present invention, it is now provided that the bus station shown in FIG. 2 can be operated with different rest states. In the case of a first rest state, circuit 5 for further processing as well as address detection 4 are deactivated. In this state, bus station 1 is not capable of correspondingly repeating at output 12 optical signals entering at input 2. In this state, the bus station is largely deactivated, thereby maintaining a particularly low energy consumption of bus station 1. However, input stage 3 is still able to detect whether optical signals are present at input 2 of the optical signal line. As long as no optical signals are present at input 2 of the signal line, bus station I remains in this rest state and maintains the minimal energy consumption. If, however, input stage 3 detects that optical signals are present, it transmits a corresponding wake-up signal to address detection 4 to activate address detection device 4, which has been switched to be inactive until this point. Thus, bus station 1 leaves the first rest state and enters the second in which output stage 13 and address detection device 4 are also activated. However, device 5 for further processing is still deactivated, so that the energy consumption of the bus station is also relatively low in this second rest state. In this second state, bus station 1 is capable of detecting addresses of messages exchanged via the signal lines. Address detection device 4 then decides as a function of the detected addresses whether bus station 1 remains in the second rest state or transitions to another state, which can, for example, be a complete activation of bus station I or else a return to the first rest stage. If address detection device 4 only detects addresses that are intended for other bus stations, it induces output stage 13 to repeat these messages without, however, activating device 5 for further processing. First when an address requiring the activation of circuit 5 for further processing is detected does address detection circuit 4 induce a corresponding wake-up signal to activate device 5 for further processing. For example, a corresponding address can be that bus station 1 is explicitly addressed. Furthermore, it can also be detected that a message is to be transmitted to all bus stations of the bus system, which also requires that device 5 for further processing be activated. Moreover, it is also possible for the bus manager to route into the bus system a message intended to extensively activate or deactivate bus stations. Accordingly, address detection device 4 would then cause bus station 1 to be activated or deactivated.

As already explained, corresponding activation commands or deactivation commands for activating or deactivating bus stations can be transmitted by a bus manager. Alternatively, it is also possible that every bus station decides of its own accord, based on internal states, whether it would like to be activated or deactivated. One possibility for such an internal state of a bus station can, for example, be that the bus station monitors how frequently messages are distributed in the bus system, or how frequently there are messages that are intended for the bus station itself. If the occurrence of messages is generally low, the bus station can decide of its own accord to largely deactivate bus station 1, i.e., address detection device 4 could also be deactivated. If messages intended for bus station 1 only occur very infrequently, yet more frequently for other bus stations, the bus station can decide to enter the second rest state in which device 5 for further processing is deactivated, yet address detection device 4 is still switched to be active. Other internal states, which cause an activation/deactivation of bus station 1, can also be corresponding requests of a user, for example, to bus station 1.

FIG. 3 shows input stage 3 in detail. Input stage 3 has a photodiode 30, which converts incident light 31 to a current. This current is then amplified in an amplification device 10 and directed to a threshold detection device 20. If the power of incident light 31 exceeds a specific threshold value, threshold detector 20 generates a wake-up signal, which is used for activating address processing device 4. Since the components shown here only have a minimal electrical energy demand, a rest state can be achieved where the energy demand of bus station 1 is very low. In the first rest state in which address detection device 4 is also deactivated, only input stage 3, as shown in FIG. 3, is activated. However, this requires very little energy, so that the energy consumption of bus station 1 is minimized.

What is claimed is:

1. A bus station for an optical bus system, comprising:
an input stage having an input for an optical signal line of the bus system; and
an address detection device for detecting addresses in bit sequences transmitted via the signal line as optical signals,
wherein, in a first rest state, the address detection device is deactivated and the input stage generates a wake-up signal for the address detection device when the input stage detects optical signals on the signal line.

2. The bus system according to claim 1, further comprising additional processing devices, and wherein, in a second rest state, the address detection device is activated and the address detection device checks bit sequences for addresses and, as a function of detected addresses, activates the additional processing devices for further processing the bit sequences.

3. The bus system according to claim 2, further comprising means for activating at least one of the first and second rest states based on received bit sequences.

4. The bus system according to claim 2, further comprising means for activating at least one of the first and second rest states based on internal states of the bus station.

5. The bus system according to claim 4, wherein the internal states result from the bus station not having received optical signals at the input for a predetermined period of time.

6. The bus system according to claim 2, further comprising an output stage having an output for an optical signal line, and wherein, in the second rest state, optical signals received at the input are repeated at the output.
